(19) United States
(12) Patent Application Publication
(10) Pub. No.: US 2014/0350206 A1
(43) Pub. Date: Nov. 27, 2014

(54) THERMOPLASTIC POLYURETHANE FOR PRODUCING HYDROPHILIC FIBERS

(71) Applicant: Bayer Intellectual Property GmbH, Monheim (DE)

(72) Inventors: Sebastian Dörr, Dusseldorf (DE); Henricus Peerlings, Spabrucken (DE); Christian Wamprecht, Neuss (DE); Hansson Dennis, Gunnilse (SE)

(73) Assignee: Bayer Intellectual Property GmbH, Monheim (DE)

(21) Appl. No.: 14/345,412

(22) PCT Filed: Sep. 17, 2012
(86) PCT No.: PCT/EP2012/068202

§ 371 Date: Mar. 18, 2014

(30) Foreign Application Priority Data
Sep. 20, 2011 (EP) 11181899.3

(51) Int. Cl. C08G 18/48; C08G 18/73; D01F 6/70; C08G 18/75

(52) U.S. Cl. CPC C08G 18/4833; C08G 18/758; C08G 18/73; D01F 6/70
USPC 528/76

(57) ABSTRACT

The invention relates to a thermoplastic polyurethane that can be obtained by reacting at least the following components: an isocyanate having two isocyanate groups, a first poly(ethylene glycol)polyether diol of the structure (HO—(CH2-CH2-O)x-H) having two isocyanate-reactive groups and a number-average molecular weight Mn>=6000 and <=16000 g/mol, a second poly(ethylene glycol)polyether diol of the structure (HO—(CH2-CH2-O)x-H) having two isocyanate-reactive groups and a number-average molecular weight Mn that corresponds to up to 80% of the number-average molecular weight Mn of the first poly(ethylene glycol)polyether diol B1), a chain extender having two isocyanate-reactive groups and a number-average molecular weight Mn>=60 and <600 g/mol, optionally a catalyst, and optionally auxiliary agents and additives, wherein the equivalent ratio of isocyanate A); to poly(ethylene glycol)polyether diols B1) and B2) lies between 1.5:1.0 and 10.0:1.0 and the NCO index, calculated from the quotient of the equivalent ratios of the isocyanate groups multiplied by 100 and the total of the isocyanate-reactive groups, is 90 to 105. The invention further relates to a method for producing the thermoplastic polyurethane according to the invention and to a thermoplastic polyurethane that can be obtained as per the method according to the invention.

The present invention provides a thermoplastic polyurethane useful for producing hydrophilic fibers in particular. The invention further provides a method of producing the thermoplastic polyurethane of the present invention and also a thermoplastic polyurethane obtainable by the method of the present invention.

Thermoplastic polyurethanes (TPUs) have considerable technical and industrial significance because of their good elastomeric properties and thermoplastic processability. TPU production, properties and applications are reviewed, for example, in Kunststoff Handbuch [G. Becker, D. Braun], Volume 7 “Polyurethanes”, Munich, Vienna, Carl Hanser Verlag, 1983.

TPUs are usually constructed from linear polyols (macrodiols), such as polyester, polyether or polycarbonate diols, organic diisocyanates and short-chain, usually difunctional alcohols (chain extenders). They can be made in a continuous manner or in a batchwise manner. The best known methods of production are the belt process (GB-A 1 057 018) and the extruder process (DE-A 19 64 834).

The thermoplastically processable polyurethane elastomers can be constructed either stepwise (pre-polymer feed process) or via simultaneous reaction of all components in one stage (one-shot feed process).

WO 2004/044028A discloses thermoplastic polyurethanes containing polyethylene glycols as structural unit. The document also describes using these thermoplastic polyurethanes to produce fibers. These are characterized by a high water vapor transmission rate, but are unable to absorb water. On the contrary, they constitute a barrier to liquid water, in keeping with an explicit statement in the application as to the problem to be solved.

The manufacture of wound dressing requires fibers capable of absorbing water to swell and thus form a gel. This enables not only removal of excess fluid from the wound but also the creation of moist conditions for the wound, which are advantageous for wound healing. An important requirement here is that the fibers should retain sufficient mechanical stability after the absorption of water has taken place, since it would otherwise be possible for portions of the fibers to remain behind in the wound, for example.

The problem addressed by the present invention was therefore that of providing a thermoplastic polyurethanes which is suitable for producing hydrophilic fibers, which are swellable by absorption of water and have sufficient mechanical stability even in the swollen state.

This problem is solved by a thermoplastic polyurethane obtainable by reacting at least the following components:
A) an isocyanate having two isocyanate groups,
B1) a first poly(ethylene glycol)polyether diol of the structure (HO—(CH₂—CH₂—O)ₓ—H) with two isocyanate-reactive groups and a number-average molecular weight Mₙ of ≧6000 and ≦16 000 g/mol,
B2) a second poly(ethylene glycol)polyether diol of the structure (HO—(CH₂—CH₂—O)ₓ—H) with two isocyanate-reactive groups and a number-average molecular weight Mₙ which is equal to from 10 to 80% of the number-average molecular weight Mₙ of the first poly(ethylene glycol)polyether diol B1),
C) a chain extender having two isocyanate-reactive groups and a number-average molecular weight Mₙ of ≧60 and <600 g/mol,
D) optionally a catalyst, and
E) optionally auxiliaries and added substances,
characterized in that said chain extender C) is at least one compound selected from ethanediol, 1,6-hexanediol, 1,4-butanediol, 1,12-dodecanediol, isophoronediamine, ethylenediamine, 1,2-propylenediamine, 1,3-propylenediamine, N-methylpropylene-1,3-diamine, N,N′-dimethylethylenediamine, terephthalic acid bis(ethylene glycol), terephthalic acid bis-1,4-butanediol, 1,4-di(-hydroxyethyl)hydroquinone, preferably ethanediol, 1,6-hexanediol, 1,4-butanediol, 1,12-dodecanediol and more preferably 1,4-butanediol, and
wherein the equivalence ratio of said isocyanate A) to said poly(ethylene glycol)polyether diols B1) and B2) is between 1.5:1.0 and 10.0:1.0 and the NCO index, formed by multiplying the quotient of the equivalence ratios of the isocyanate groups and the sum total of the isocyanate-reactive groups by 100, is from 90 to 105.

It has transpired that the thermoplastic polyurethane of the present invention can be used to produce hydrophilic fibers which are capable of absorbing water by gelling and have sufficient mechanical stability in the swollen state.

Isocyanate-reactive groups herein are in particular hydroxyl and primary/secondary amino groups.

In a preferred embodiment of the invention, the NCO index is from 92 to 104, preferably from 95 to 102 and more preferably from 97 to 100.

Description of individual components

### Isocyanates A)

As isocyanate A) there can be used, for example, aliphatic, cycloaliphatic, araliphatic, heterocyclic and aromatic diisocyanates as described for instance in Justus Liebigs Annalen der Chemie, 562, pages 75 to 136.

Examples of isocyanates A) are ethylene diisocyanate, 1,4-tetramethylene diisocyanate, 1,12-dodecane diisocyanate, 1,6-hexamethylene diisocyanate, cycloaliphatic diisocyanates, such as isophorone diisocyanate, 1,4-cyclohexane diisocyanate, 1-methyl-2,4- and 2,6-cyclohexane diisocyanate and also the corresponding isomeric mixtures, 4,4′-, 2,4′- and 2,2′-dicyclohexylmethane diisocyanate and also the corresponding isomeric mixtures and aromatic diisocyanates, such as 2,4′-tolylene diisocyanate, mixtures of 2,4- and 2,6-tolylene diisocyanate, 4,4′-diphenylmethane diisocyanate, 2,4-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and/or 2,4′-diphenylmethane diisocyanates, 4,4′-diisocyanatodiphenyl-1,2-ethane and 1,5-naphthylene diisocyanate.

However, use of aliphatic and/or cycloaliphatic diisocyanates is preferred.

It is therefore particularly preferable to use one or more compounds from the group 1,6-hexamethylene diisocyanate, isophorone diisocyanate and dicyclohexylmethane diisocyanate as isocyanate A.

Yet it is very particularly preferable to use exclusively 1,6-hexamethylene diisocyanate.

Polyethylene glycols B1) and B2)

Poly(ethylene glycol)polyether diols B1) and B2) are compounds which are obtainable in a conventional manner by alkoxylating suitable difunctional starter molecules with ethylene oxide (as described in, for example, Ullmanns Encyclopadie der technischen Chemie, 4th edition, volume 19, Verlag Chemie, Weinheim pp. 31-38). Ethylene oxide aside, still further epoxides such as, for example, propylene oxide and butylene oxide can be used for preparing the poly(ethylene glycol)polyether diols, in which case the mass fraction of these components, based on the particular polyethylene glycol, is preferably less than 30 wt %, more preferably less than 15 wt % and even more preferably less than 5 wt %. In a very particularly preferred embodiment, no further epoxide is used besides ethylene oxide. As starter molecules there can be used diols such as, for example, ethylene glycol, 1,2-propanediol, 1,3-propanediol, 1,3-butanediol, 1,4-butanediol, 1,6-hexanediol, 1,8-octanediol, neopentylglycol, 1,4-bishydroxymethylcyclohexane, 2-methyl-1,3-propanediol, 2,2,4-trimethylpentane-1,3-diol, di-, tri- or tetraethylene glycol, dipropylene glycol, dibutylene glycol, polybutylene glycols or bisphenol A.

In a further advantageous embodiment, the first poly(ethylene glycol)polyether diol B1) has a number-average molecular weight Mn of 6000 to 12 000 g/mol, preferably of 6000 to 10 000 g/mol, more preferably of 6000 to 8000 g/mol and most preferably of 8000 g/mol.

In a further advantageous embodiment, the second poly(ethylene glycol)polyether diol B2) has a number-average molecular weight Mn of 600 to 4000 g/mol, preferably of 1000 to 3000 g/mol, more preferably of 1800 to 2200 g/mol and most preferably of 2000 g/mol.

In a likewise preferred embodiment, the number-average molecular weight Mn of said second poly(ethylene glycol)polyether diol B2) is equal to from 10 to 70%, preferably from 15 to 50% and more preferably from 15 to 33% of the number-average molecular weight Mn of said first poly(ethylene glycol)polyether diol B1).

In a similarly advantageous embodiment, the weight ratio of said first poly(ethylene glycol)polyether diol) B1 to said) second poly(ethylene glycol)polyether diol B2) is in the range from 1 to 30, preferably from 5 to 25 and most preferably from 10 to 20.

The content level of diols having number-average molecular weights Mn of 600 to 16 000 g/mol that are present alongside B) is below 20 wt %, preferably below 10 wt % and most preferably below 5 wt % each based on total polyurethane mass.

In a particularly preferred embodiment of the invention, aside from said poly(ethylene glycol)polyether diols B1) and B2) no further diols having a number-average molecular weight Mn of ≧600 and ≦16 000 g/mol are co-reacted.

In a preferred embodiment, the poly(ethylene glycol)polyether diols B1) and B2) are dried before the reaction, for example under reduced pressure, e.g., at 1 to 800 mbar, and elevated temperature, e.g., at 70 to 150° C.; this achieves a reduction in the traces of water present.

### Chain Extender C)

As chain extender C) there can be used in particular an aliphatic diol or a (cyclo)aliphatic diamine. Examples of suitable aliphatic diols are aliphatic diols having 2 to 14 carbon atoms such as ethanediol, 1,6-hexanediol, 1,12-dodecanediol and, in particular, 1,4-butanediol. The (cyclo)aliphatic diamines can be, in particular, isophoronediamine, ethylenediamine, 1,2-propylenediamine, 1,3-propylenediamine, N-methylpropylene-1,3-diamine, N,N′-dimethylethylenediamine. Mixtures of chain extenders mentioned above can also be used. Minor amounts of triols can also be added alongside.

However, the chain extender C) is preferably at least one compound selected from ethanediol, 1,6-hexanediol, 1,4-butanediol, 1,12-dodecanediol, isophoronediamine, ethylenediamine, 1,2-propylenediamine, 1,3-propylenediamine, N-methylpropylene-1,3-diamine, N,N′-dimethylethylenediamine, more preferably ethanediol, 1,6-hexanediol, 1,12-dodecanediol and 1,4-butanediol and most preferably 1,4-butanediol.

In a very particularly preferred embodiment, however, exclusively 1,4-butanediol is used as component C).

Especially applications having comparatively low photostability requirements can also utilize aromatic diols and diamines Examples of suitable aromatic diols are diesters of terephthalic acid with glycols having 2 to 4 carbon atoms, e.g., terephthalic acid bis(ethylene glycol) or terephthalic acid bis-1,4-butanediol, hydroxyalkylene ethers of hydroquinone, e.g., 1,4-di(-hydroxyethyl)hydroquinone, and ethoxylated bisphenols. Examples of suitable aromatic diamines are 2,4-tolylenediamine and 2,6-tolylenediamine, 3,5-diethyl-2,4-tolylenediamine and 3,5-diethyl-2,6-tolylenediamine and primary mono-, di-, tri- or tetraalkyl-substituted 4,4′-diaminodiphenylmethanes.

### Catalyst D)

Suitable catalysts D) are the tertiary amines which are known and customary in the prior art, e.g., triethylamine, dimethylcyclohexylamine, N-methylmorpholine, N,N′-dimethyl-piperazine, 2-(dimethylaminoethoxy)ethanol, diazabicyclo[2.2.2]octane and the like, and also specifically organic metal compounds such as titanic esters, iron compounds or tin compounds such as tin diacetate, tin dioctoate, tin dilaurate or the tin dialkyl salts of aliphatic carboxylic acids such as dibutyltin diacetate or dibutyltin dilaurate or the like. Preferred catalysts are organic metal compounds, in particular titanic esters and iron, tin, zirconium and bismuth compounds.

The total amount of catalysts in the TPUs of the present invention is preferably from 0 to 5 wt %, more preferably from 0 to 2 wt % and even more preferably from 0.01 to 0.5 wt %, based on the total amount of TPUs. Acid components can also be added to regulate the catalytic effect and also for stabilization.

### Auxiliaries and Added Substances E)

The auxiliary and added-substance materials E) customary in TPU chemistry can be present. Typical auxiliary and added-substance materials are lubricants and demolding agents, such as fatty acid esters, their metal soaps, fatty acid amides, fatty acid ester amides and silicone compounds, plasticizers, anti-blocking agents, inhibitors, stabilizers against hydrolysis, heat and discoloration, dyes, pigments, biocidally acting substances and also inorganic and/or organic fillers and mixtures thereof.

Further particulars regarding the recited auxiliary and added-substance materials are found in the technical literature such as, for example, J. H. Saunders, K. C. Frisch: “High Polymers”, Volume XVI, Polyurethanes, Parts 1 and 2, Interscience Publishers 1962 and 1964, respectively.

Antioxidants to be used with preference are the familiar additives with phenolic structural elements, as described for example in R. Gächter, H. Müller (Ed.): Taschenbuch der Kunststoff-Additive, 3^{rd} edition, Hanser Verlag, Munich 1989.

As possible photostabilizers there can be used UV stabilizers, antioxidants and/or HALS compounds. Further particulars are found in, for example, H. Zweifel, Plastics Additives Handbook, 2001, 5th Ed., Carl Hanser Verlag, Munich.

Typically, up to 10 wt %, based on the overall amount of TPU, is added of usual auxiliary and added-substance materials E).

The invention further provides a method of producing a thermoplastic polyurethane according to the present invention, which comprises preparing a mixture I) of said poly(ethylene glycol)polyether diols) B1), B2) and said chain extender C) and intensively mixing said mixture I) with said isocyanate A).

In a preferred embodiment of the method according to the present invention, said mixture I) is mixed with said isocyanate A) for not more than 5 seconds until homogeneous, wherein the temperatures of said mixture I) and of said isocyanate A) before said mixing are ≧60 and <150° C. and the difference between the temperatures is <50° C. and preferably <20° C.

In an embodiment which is likewise preferred, said mixture I) is mixed with said isocyanate A) in a static mixer having a length/diameter ratio ranging from 8:1 to 16:1.

The thermoplastic polyurethane obtained can optionally also be pelletized in a further step.

The invention further provides a method of continuous production of thermoplastic polyurethanes according to the present invention, which is characterized in that the mixture I) and the chain extender C) are mixed in a continuous manner, then made to react with the isocyanate A), the reaction is completed in a discharge vessel and the product is optionally pelletized. This version of the method is particularly preferred.

The thermoplastic polyurethanes of the present invention can also be obtained by the pre-polymer process, in which case the isocyanate A) is reacted with the poly(ethylene glycol)polyether diols) B1) and B2) to form a prepolymer in an initial step and this prepolymer is mixed, and reacted, with the chain extender C) in a second step.

The TPUs of the present invention can be used in the manufacture of fibers or shaped articles, for producing extrudates (e.g., self-supporting films/sheets) and injection moldings. Preference is given to the production of fibers, this can be further processed into wovens, knits or bonded and unbonded fibrous webs. The particular production and processing methods and techniques are known to a person skilled in the art.

The invention will now be more particularly elucidated by means of examples.

### EXAMPLES

Unless otherwise stated, all amounts, proportions and percentages are by weight and are based on the overall amount or weight of the compositions.

Unless stated otherwise, all analytical measurements relate to measurements at temperatures of 23° C.

Spinnability was tested with an extruder having one screw (18×520 mm) with mixing zones and a spinneret die having 2 to 24 holes. The rate of extrusion was adjusted such that the residence time in the extruder was about 10 minutes, and the temperature of the first thermostating zones was 85° C. and that of the zones upstream of the spinneret die was 120 to 210° C. The fibers were taken up with a winding machine.

### Procedures:

NCO contents, unless expressly mentioned otherwise, were determined volumetrically in accordance with DIN-EN ISO 11909.

The check for free NCO groups was performed using IR spectroscopy (band at 2260 cm-1).

The number-average molecular weight Mₙ is determined by gel permeation chromatography versus polystyrene standard in tetrahydrofuran at 23° C.

### Materials:

The isocyanates used come from Bayer MaterialScience AG, Leverkusen, Del.

Further chemicals—unless stated otherwise—come from Sigma-Aldrich Chemie GmbH, Taufkirchen, Del.

### Solution A

8.298 g of sodium chloride and 0.368 g of calcium chloride were dissolved in one liter of deionized water.
Poly(ethylene glycol)polyether diols
PEG 8000: polyethylene glycol, number-average molecular weight 8000 g/mol.
PEG 6000: polyethylene glycol, number-average molecular weight Mₙ 8000 g/mol.
PEG 4000: polyethylene glycol, number-average molecular weight Mₙ 4000 g/mol.
PEG 2000: polyethylene glycol, number-average molecular weight Mₙ 2000 g/mol.
PEG 1000: polyethylene glycol, number-average molecular weight Mₙ 1000 g/mol.

### Preparation of Thermoplastic Polyurethanes

### Example 1

### Inventive Example

A mixture of 547 g of PEG 8000 and 34.7 g of PEG 2000 were dried for 2 hours at 100° C. by stirring in a vessel (vacuum about 20 mbar). The mixture was subsequently stirred under nitrogen and admixed with 0.34 g of dibutyl phosphate and 9.6 g of 1,12-dodecanediol. After heating to 120° C., 34.9 g of methylene bis(4-cyclohexyl isocyanate) and also 0.34 g of tin(II) ethylhexanoate were added and the vessel was heated until the temperature had attained a figure of 196° C. (which took about 20 minutes). The resultant polymer was subsequently poured into a dish and stored at 105° C. for a further hour.

### Example 2

### Inventive Example

A mixture of 530.5 g of PEG 8000 and 33.6 g of PEG 2000 were dried for 2 hours at 100° C. by stirring in a vessel (vacuum about 20 mbar). The mixture was subsequently stirred under nitrogen and admixed with 0.66 g of dibutyl phosphate and 6.27 g of 1,4-butanediol. After heating to 120° C., 41.1 g of methylene bis(4-cyclohexyl isocyanate) and also 0.34 g of Borchikat 24 (OMG Borchers GmbH, Langenfeld/Germany) were added and the vessel was heated until the temperature had attained a figure of 196° C. (which took about 15 minutes). The resultant polymer was subsequently poured into a dish and stored at 105° C. for a further hour.

### Example 3

### Inventive Example

A mixture of 526.1 g of PEG 8000, 33.4 g of PEG 2000 and 16.74 g of hydroquinone bis(2-hydroxyethyl) ether were dried for 2 hours at 100° C. by stirring in a vessel (vacuum about 20 mbar). The mixture was subsequently stirred under nitrogen and admixed with 0.3 g of dibutyl phosphate. After heating to 110° C., 26.9 g of 1,6-hexamethylene diisocyanate and also 0.34 g of tin(II) ethylhexanoate were added and the vessel was heated until the temperature had attained a figure of 180° C. (which took about 5 minutes). The resultant polymer was subsequently poured into a dish and stored at 105° C. for a further hour.

### Example 4

### Inventive Example

A mixture of 549.7 g of PEG 8000 and 34.8 g of PEG 2000 were dried for 2 hours at 100° C. by stirring in a vessel (vacuum about 20 mbar). The mixture was subsequently stirred under nitrogen and admixed with 1.88 g of dibutyl phosphate and 6.5 g of 1,4-butanediol. After heating to 165° C., 38.08 g of 4,4-diphenylmethane diisocyanate were added and the vessel was heated until the temperature had attained a figure of 196° C. (which took about 5 minutes). The resultant polymer was subsequently poured into a dish and stored at 105° C. for a further hour.

### Example 5

### Inventive Example

A mixture of 549.7 g of PEG 8000 and 44.7 g of PEG 1000 were dried for 2 hours at 100° C. by stirring in a vessel (vacuum about 20 mbar). The mixture was subsequently stirred under nitrogen and admixed with 0.30 g of dibutyl phosphate and 15.2 g of 1,4-butanediol and also 0.30 g of tin(II) ethylhexanoate. After heating to 110° C., 45.8 g of 1,6-hexamethylene diisocyanate were added and the vessel was heated until the temperature had attained a figure of 160° C. (which took about 4 minutes). The resultant polymer was subsequently poured into a dish and stored at 105° C. for a further hour.

### Example 6

### Comparative Example

575.4 g of PEG 8000 were dried for 2 hours at 100° C. by stirring in a vessel (vacuum about 20 mbar). The mixture was subsequently stirred under nitrogen and admixed with 0.30 g of dibutyl phosphate and 12.4 g of 1,4-butanediol and also 0.30 g of tin(II) ethylhexanoate. After heating to 110° C., 35.1 g of 1,6-hexamethylene diisocyanate were added and the vessel was heated until the temperature had attained a figure of 160° C. (which took about 6 minutes). The resultant polymer was subsequently poured into a dish and stored at 105° C. for a further hour.

### Example 7

### Comparative Example

528.0 g of PEG 2000 were dried for 2 hours at 100° C. by stirring in a vessel (vacuum about 20 mbar). The mixture was subsequently stirred under nitrogen and admixed with 0.38 g of dibutyl phosphate and 24.1 g of 1,4-butanediol and also 0.38 g of tin(II) ethylhexanoate. After heating to 110° C., 87.0 g of 1,6-hexamethylene diisocyanate were added and the vessel was heated until the temperature had attained a figure of 160° C. (which took about 3 minutes). The resultant polymer was subsequently poured into a dish and stored at 105° C. for a further hour.

### Example 8

### Comparative Example

538.5 g of PEG 2000 were dried for 2 hours at 100° C. by stirring in a vessel (vacuum about 20 mbar). The mixture was subsequently stirred under nitrogen and admixed with 0.30 g of dibutyl phosphate and 11.4 g of 1,4-butanediol and also 0.30 g of tin(II) ethylhexanoate. After heating to 110° C., 68.7 g of 1,6-hexamethylene diisocyanate were added and the vessel was heated until the temperature had attained a figure of 160° C. (which took about 2 minutes). The resultant polymer was subsequently poured into a dish and stored at 105° C. for a further hour.

### Example 9

### Comparative Example

528.0 g of PEG 4000 were dried for 2 hours at 100° C. by stirring in a vessel (vacuum about 20 mbar). The mixture was subsequently stirred under nitrogen and admixed with 0.38 g of dibutyl phosphate and 12.4 g of 1,4-butanediol and also 0.30 g of tin(II) ethylhexanoate. After heating to 110° C., 45.8 g of 1,6-hexamethylene diisocyanate were added and the vessel was heated until the temperature had attained a figure of 160° C. (which took about 4 minutes). The resultant polymer was subsequently poured into a dish and stored at 105° C. for a further hour.

### Processing and Performance Tests

The thermoplastic polyurethanes obtained according to Examples 1 to 9 were cooled down to room temperature, pelletized and dried in an air stream. Each pellet material was then processed via a temperature-regulatable extruder with dies into fibers. The resultant fibers were wound up on a rotating roll. All the while the fibers were evaluated for their ease of production (assessment criteria: good product flow, rare fiber breakage, low number of gel particles) and for their ease of further processing (assessment criteria: good winding and unwinding, mechanical strength, low tackiness).

The pellets and fibers were also subjected to tests of swelling in Solution A. The desideratum here was high absorption (increase in mass after 10 minutes in an excess of Solution A). At the same time, the fiber should not dissolve. It should form a compact, transparent and stable gel which, in relation to the mass of the unswollen polymer, has absorbed at least 20 times the mass of Solution A.

### Evaluation of Individual Runs

Grading scale: 1—very good to 5—very poor or unworkable:

| | | Mechanical | | Weight increase after |
|---|---|---|---|---|
| Run | | properties of | Gel | 10 minutes in g per 1 g |
| No. | Spinnability | fibers | properties | of polymer |
| 1)* | 2 | 1 | 1 | 29 |
| 2)* | 1 | 2 | 2 | 29 |
| 3)* | 2 | 2 | 3 | 25 |
| 4)* | 2 | 2 | 2 | 25 |
| 5)* | 1 | 1 | 2 | 23 |
| 6) | 5 | 3-4 | 5 | cannot be determined |
| | | | (dissolved) | (because dissolved) |
| 7) | 4 | 4 | 4 | 10 |
| 8) | 4 | 4 | 4 | 6 |
| 9) | 3 | 2 | 4 | 18 |
| | | | (partly | |
| | | | dissolved)) | |

*inventive example

Processability in all steps leading to fiber was good and fiber properties were good in the inventive examples. The inventive fibers absorbed a large amount of Solution A whilst forming a gel wherein the swollen fibers exhibited sufficient mechanical stability. By contrast, the thermoplastic polyurethanes of the comparative examples only gave qualitatively distinctly inferior fibers which, furthermore, could only absorb less Solution A. Moreover, these fibers were devoid of mechanical stability.

1-12. (canceled)

13. A thermoplastic polyurethane obtained by reacting at least the following components:
A) an isocyanate having two isocyanate groups,
B1) a first poly(ethylene glycol)polyether diol of the structure (HO—(CH₂—CH₂—O)ₓ—H) with two isocyanate-reactive groups and a number-average molecular weight Mₙ of ≧6000 and ≦16 000 g/mol,
B2) a second poly(ethylene glycol)polyether diol of the structure (HO—(CH₂—CH₂—O)ₓ—H) with two isocyanate-reactive groups and a number-average molecular weight Mₙ which is equal to from 10 to 80% of the number-average molecular weight Mₙ of the first poly(ethylene glycol)polyether diol B1),
C) a chain extender having two isocyanate-reactive groups and a number-average molecular weight Mₙ of ≧60 and <600 g/mol,
D) optionally a catalyst, and
E) optionally an auxiliary and an added substance,
wherein said chain extender C) is at least one compound selected from the group consisting of ethanediol, 1,6-hexanediol, 1,4-butanediol, 1,12-dodecanediol, isophoronediamine, ethylenediamine, 1,2-propylenediamine, 1,3-propylenediamine, N-methylpropylene-1,3-diamine, N,N′-dimethylethylenediamine, terephthalic acid bis(ethylene glycol), terephthalic acid bis-1,4-butanediol, and 1,4-di(-hydroxyethyl)hydroquinone, and
wherein the equivalence ratio of said isocyanate A) to said poly(ethylene glycol)polyether diols B1) and B2) is between 1.5:1.0 and 10.0:1.0 and the NCO index, formed by multiplying the quotient of the equivalence ratios of the isocyanate groups and the sum total of the isocyanate-reactive groups by 100, is from 90 to 105.

14. The thermoplastic polyurethane as claimed in claim 13, wherein aside from said poly(ethylene glycol)polyether diols B1) and B2) no further diol having a number-average molecular weight Mn of ≧600 and ≦16 000 g/mol is co-reacted.

15. The thermoplastic polyurethane as claimed in claim 13, wherein the weight ratio of said first poly(ethylene glycol)polyether diol) B1) to said second poly(ethylene glycol)polyether diol B2) is in the range from 1 to 30.

16. The thermoplastic polyurethane as claimed in claim 13, wherein the isocyanate comprises one or more compounds selected from the group consisting of hexamethylene diisocyanate, dicyclohexylmethane diisocyanate, and isophorone diisocyanate.

17. The thermoplastic polyurethane as claimed in claim 13, wherein the second poly(ethylene glycol)polyether diol) B2) has a number-average molecular weight Mn of 600 to 4000 g/mol.

18. The thermoplastic polyurethane as claimed in claim 13, wherein the number-average molecular weight Mn of said second poly(ethylene glycol)polyether diol B2) is equal to from 10 to 70% of the number-average molecular weight Mn of said first poly(ethylene glycol)polyether diol B1).

19. The thermoplastic polyurethane as claimed in claim 13, wherein said chain extender C) is an aliphatic diol or a (cyclo)aliphatic diamine.

20. The thermoplastic polyurethane as claimed in claim 13, wherein the NCO index is from 92 to 104.

21. A method of producing a thermoplastic polyurethane as claimed in claim 13, comprising preparing a mixture I) of said poly(ethylene glycol)polyether diols) B1), B2) and said chain extender C) and mixing intensively said mixture I) with said isocyanate A).

22. The method as claimed in claim 21, wherein said mixture I) are mixed with said isocyanate A) for not more than 5 seconds until homogeneous, wherein the temperatures of said mixture I) and of said isocyanate A) before said mixing are ≧60 and ≦150° C. and the difference between the temperatures is ≦50° C.

23. The method as claimed in claim 21, wherein said mixture I) is mixed with said isocyanate A) in a static mixer having a length/diameter ratio ranging from 8:1 to 16:1.

24. A thermoplastic polyurethane obtained by the method of claim 21.
